(19) United States
(12) Patent Application Publication
(10) Pub. No.: US 2025/0274541 A1
(43) Pub. Date: Aug. 28, 2025

(54) CRADLES AND CASES FOR MOBILE DEVICES WITH A DOCKING BUTTON AND METHODS OF MAKING AND USING

(71) Applicant: National Products, Inc., Seattle, WA (US)

(72) Inventor: Jeffrey D. Carnevali, Seattle, WA (US)

(21) Appl. No.: 18/590,837

(22) Filed: Feb. 28, 2024

(51) Int. Cl. H04M 1/04

(52) U.S. Cl. CPC H04M 1/04

(57) ABSTRACT

A cradle for a mobile device includes a cradle base defining a docking button indentation having an indentation perimeter for receiving a docking button disposed on, or coupled to, a back surface of the mobile device or of a case containing the mobile device, the docking button having a lateral cross-sectional shape complementary to the indentation perimeter; a bottom device receiver coupled to the cradle base, the bottom device receiver including electrical contacts for making contact with contacts on the mobile device or the case containing the mobile device; and a latch coupled to the cradle base and manually moveable between a latched position and an unlatched position, wherein, in the latched position, the latch directly engages the docking button and, in the unlatched position, the latch disengages from, or is not engage with, the docking button to permit loading or unloading of the mobile device on the cradle.

### FIELD

The present invention is directed to cradles for a mobile device. The present invention is also directed to cradles and cases for a mobile device that include a docking button arrangement.

### BACKGROUND

Mobile devices, such as smartphones, cellular or mobile phones, tablets, personal data assistants, and other portable devices, are now ubiquitous. Cradles can be used to protect the mobile device, to mount the mobile device onto a surface or object, or to provide power, or data to or from, the mobile device, or any combination thereof.

### BRIEF SUMMARY

One embodiment is a cradle for a mobile device. The cradle includes a cradle base defining a docking button indentation having an indentation perimeter, wherein the docking button indentation is configured to receive a docking button disposed on, or coupled to, a back surface of the mobile device or of a case containing the mobile device, the docking button having a lateral cross-sectional shape complementary to the indentation perimeter of the docking button indentation; a bottom device receiver coupled to the cradle base and configured to receive a bottom portion of the mobile device or the case containing the mobile device, the bottom device receiver including a plurality of electrical contacts configured for making contact with contacts on the mobile device or the case containing the mobile device; and a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

Another embodiments is a kit for docking a mobile device. The kit includes a docking button configured for attachment to a back surface of the mobile device or of a case containing the mobile device, the docking button having a lateral cross-sectional shape; and a cradle configured for docking the mobile device. The cradle includes a cradle base defining a docking button indentation having an indentation perimeter complementary to the lateral cross-sectional shape of the docking button, a bottom device receiver coupled to the cradle base and configured to receive a bottom portion of the mobile device or the case containing the mobile device, the bottom device receiver including a plurality of electrical contacts configured for making contact with contacts on the mobile device or the case containing the mobile device, and a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

A further embodiments is a kit for docking a mobile device. The kit includes a case arrangement having a case configured for containing the mobile device, the case including a back surface, and a docking button attached to the back surface of the case, the docking button having a lateral cross-sectional shape. The kit also includes a cradle configured for docking the mobile device, the cradle including a cradle base defining a docking button indentation having an indentation perimeter complementary to the lateral cross-sectional shape of the docking button, a bottom device receiver coupled to the cradle base and configured to receive a bottom portion of the case containing the mobile device, the bottom device receiver including a plurality of electrical contacts configured for making contact with contacts on the mobile device or the case containing the mobile device, and a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

In at least some embodiments, the bottom device receiver is configured to retain a bottom portion of the mobile device or the case. In at least some embodiments, a portion of the latch defines a portion of the indentation perimeter of the docking button indentation. In at least some embodiments, the docking button indentation has a polygonal lateral cross-sectional shape.

In at least some embodiments, the indentation perimeter of the docking button indentation has a polygonal shape. In at least some embodiments, the polygonal shape is selected from triangular, square, rectangular, rhomboidal, trapezoidal, pentagonal, hexagonal, octagonal, or decagonal.

In at least some embodiments, the cradle further includes a latch lock manually moveable between a locked position and an unlocked position, wherein, in the locked position, the latch lock hinders the latch moving to the unlatched position and, in the unlocked position, the latch lock allows the latch to move between the latched position and the unlatched position. In at least some embodiments, the latch lock includes a latch bar and a lock actuator coupled to the latch bar and configured to extend the latch bar when the latch lock is moved to the locked position and to retract the latch bar when the latch lock is moved to the unlocked position. In at least some embodiments, the latch lock further includes a latch stop configured to engage a portion of the latch when the latch moves to the unlatched position to resist overbending the portion of the latch.

In at least some embodiments, the latch includes a latch arm coupled to the cradle body, a handle coupled to the latch arm, and a latching lip coupled to the latch arm, wherein the latching lip is configured, in the latched position, to engage the docking button. In at least some embodiments, the kit further includes a mounting neck configured for disposition between the docking button and the mobile device or case.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective side view of one embodiment of a cradle for a mobile device, according to the invention;

FIG. 1B is a schematic perspective side view of the cradle of FIG. 1A from another angle;

FIG. 2A is a schematic perspective back view of a mobile device contained within a case and having a docking button coupled thereto;

FIG. 2B is a schematic perspective back view of the cradle of FIG. 1A received the mobile device of FIG. 2A, according to the invention;

FIG. 2C is a schematic perspective front view of the cradle of FIG. 1A received the mobile device of FIG. 2A, according to the invention;

FIG. 3 is a schematic side view of the cradle of FIG. 1A during the process of receiving the mobile device of FIG. 2A, according to the invention;

FIG. 4A is a schematic side view of another embodiment of a cradle with a latch lock and the mobile device of FIG. 2A received by the cradle, according to the invention;

FIG. 4B is a schematic perspective cross-sectional view of the cradle of FIG. 4A during the process of receiving the mobile device of FIG. 2A, according to the invention;

FIG. 5A is a schematic perspective side view of a portion of the cradle of FIG. 4A with the latch lock in an unlocked position, according to the invention;

FIG. 5B is a schematic perspective side view of a portion of the cradle of FIG. 4A with the latch lock in a locked position, according to the invention;

FIG. 6A is a schematic perspective partial-cross-sectional view of a portion of the cradle of FIG. 4A with the latch lock in an unlocked position, according to the invention; and

FIG. 6B is a schematic perspective partial-cross-sectional view of a portion of the cradle of FIG. 4A with the latch lock in a locked position, according to the invention.

### DETAILED DESCRIPTION

The present invention is directed to cradles for a mobile device. The present invention is also directed to cradles and cases for a mobile device that include a docking button arrangement.

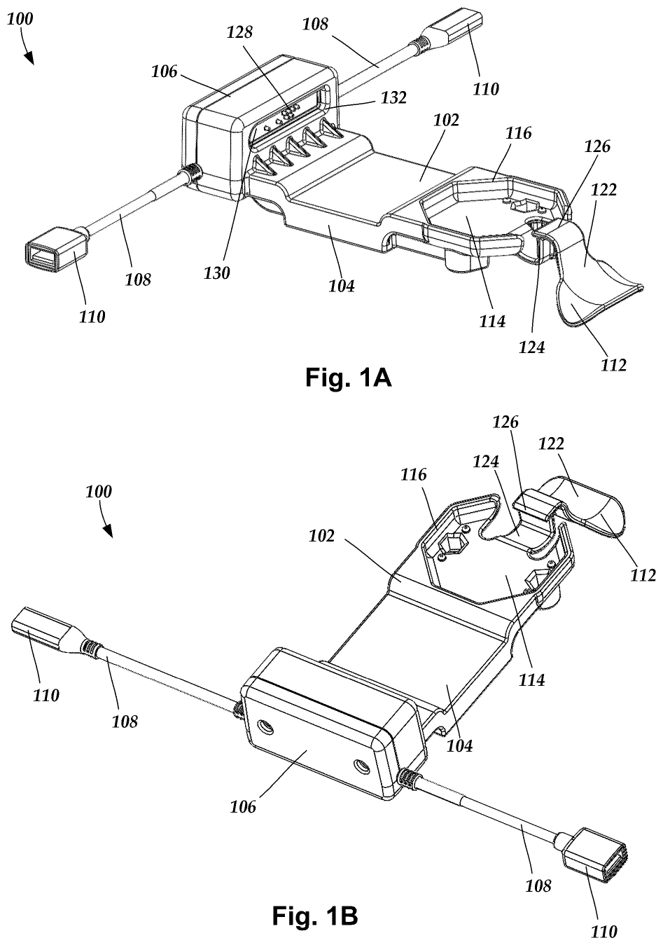

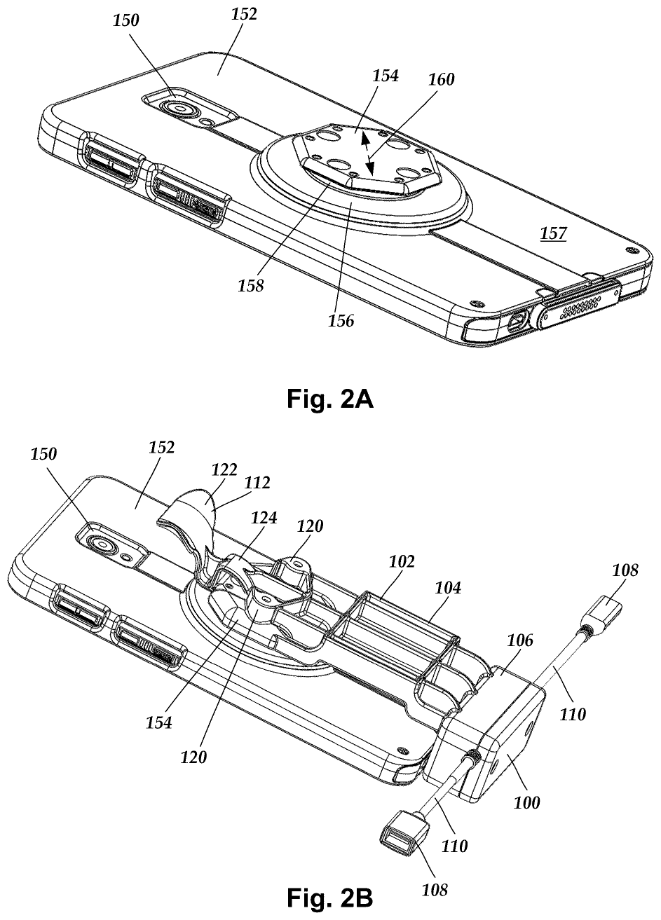

FIGS. 1A and 1B illustrate one embodiment of a cradle 100 for a mobile device 150 (FIG. 2A), such as a cellular or mobile phone, a smartphone, a tablet, a personal data assistant, or any other suitable mobile device. The cradle 100 includes a cradle body 102. The cradle body can include any suitable arrangement of components, such as, for example, a cradle base 104 and a bottom device receiver 106 coupled to, or part of, the cradle base 104, as illustrated in FIGS. 1A and 1B. In at least some embodiments, the cradle 100 includes one or more optional connector cords 108 extending from the cradle body 102 such as, for example, extending from the bottom device receiver 106. In at least some embodiments, the cradle 100 includes one or more optional connectors 110 attached to each optional connector cord 108. Other cradles may have more or fewer components. In at least some embodiments, the cradle 100 includes a latch 112.

The bottom device receiver 106 is attached to the cradle base 104 and may be integrally formed with (e.g., permanently attached to or permanently part of) the cradle base or may be detachable from the cradle base. In at least some embodiments, the bottom device receiver 106 includes one or more contacts 128 for making contact with contacts on the mobile device 150 (FIG. 2A) or a case 152 (FIG. 2A) containing the mobile device. Any arrangement of the contacts 128 can be used including, but not limited to, an arrangement of the contacts in one or more rows. When the arrangement includes two or more rows, the contacts in the rows can be aligned or staggered relative to each other. In other embodiments of the cradle 100, the contacts 128 can be positioned anywhere in or on the cradle body 102 such as, for example, in or on the cradle base 104. In at least some embodiments, the contacts 128 are pogo pins or other biasing contacts that can move up or down relative to the cradle body 102 such as, for example, the bottom device receiver 106.

The contacts 128 make electrical contact with contacts on the mobile device 150 (FIG. 2A) or a case 152 (FIG. 2A) disposed on the mobile device when the mobile device is inserted into (e.g., received by) the cradle 100. Examples of cases with contacts include, but are not limited to, the cases, covers, or skins described in U.S. Pat. Nos. 9,195,279; 9,331,444; 9,529,387; 9,602,639; 9,632,535; 9,706,026; 10,050,658; 10,054,984; 10,389,399; 10,454,515; and 10,630,334 and U.S. patents applications Ser. Nos. 16/853,544 and 16/866,156, all of which are incorporated herein by reference in their entireties. The contacts 128 in the cradle 100 can be used to transfer power to the mobile device 150 (FIG. 2A) from a power source, transfer data between the mobile device and a data source, or any combination thereof.

In at least some embodiments, the bottom device receiver 106 which includes a recess 130 surrounded by a rim 132 that may facilitate retention of the mobile device in the cradle 100. In at least some embodiments, the recess 130, rim 132, and contacts 128 form a female connector. In at least some embodiments, the shape of the recess 130 and rim 132 are complementary to a male structure of a case 152 (FIG. 2A) (see, for example, the cases, covers, or skins in the references cited above) or mobile device 150 (FIG. 2A).

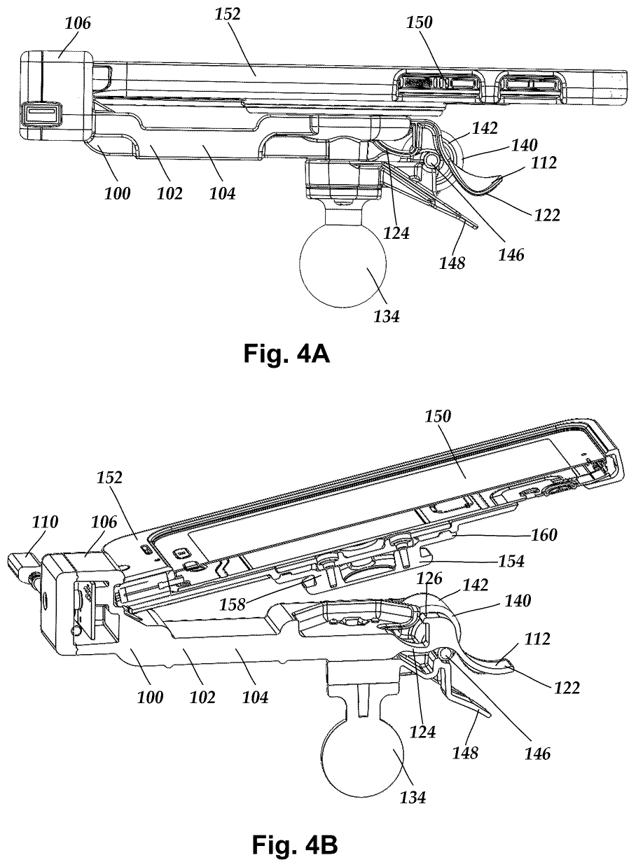

In at least some embodiments, an optional mount 134 (FIG. 4A) can be coupled, or coupleable, to one or more mounting posts 120 (FIG. 2B) or any other suitable mounting element(s) of the cradle 100. Non-limiting examples of mounts can be found at U.S. Pat. Nos. 5,845,885; 6,561,476; 7,320,50; 7,997,554; 8,454,178; 8,505,861; 9,831,904; RE42,060; RE42,581; and RE43,806, all of which are incorporated herein by reference in their entireties.

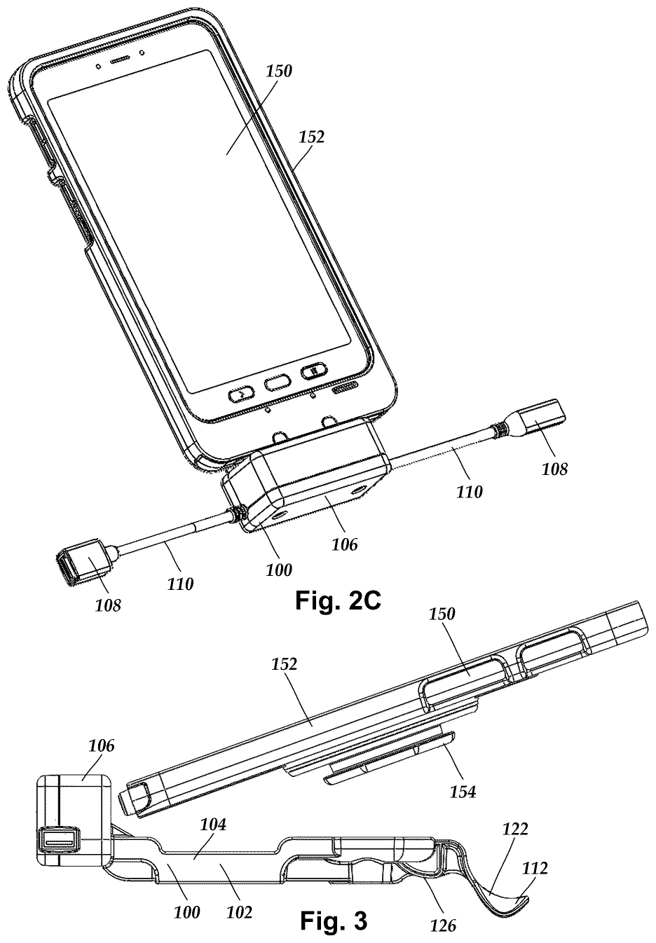

FIG. 2A illustrates one embodiment of a mobile device 150, a case 152 containing the mobile device, and a docking button 154 attached to the case (or alternatively attached to the mobile device) and FIGS. 2B and 2C illustrate the mobile device 150 of FIG. 2A received by (e.g., docked on) the cradle 100. FIG. 3 illustrates the mobile device 150 in the process of being received by the cradle 100. The cradle base 104 defines a docking button indentation 114 to receive a docking button 154 attached to the mobile device 150 or a case 152 containing the mobile device. In at least some embodiments, the docking button indentation 114 of the cradle base 104 has an indentation perimeter 116 and a lateral cross-sectional shape and the docking button 154 has a lateral cross-sectional shape complementary to the indentation perimeter or the lateral cross-sectional shape of the docking button indentation.

In at least some embodiments, the docking button indentation 114 has a non-circular indentation perimeter 116 or non-circular lateral cross-sectional shape and the docking button 154 has a non-circular lateral cross-sectional shape. In at least some embodiments, this facilitates maintaining alignment of the mobile device 150 with the cradle 100 because the docking button is not rotatable when received in the docking button indentation. Examples of indentation perimeter shapes and lateral cross-sectional shapes of a docking button indentation 114, as well as lateral cross-sectional shapes of a docking button 154, include, but are not limited to, circular, oval, triangular, square, rectangular, rhomboidal, trapezoidal, pentagonal, hexagonal, octagonal (as illustrated in FIG. 2A), decagonal, or the like. In at least some embodiments, the indentation perimeter shape and lateral cross-sectional shape of the docking button indentation 114 and the lateral cross-sectional shape of the docking button 154 are polygonal, regular polygonal, or irregular polygonal. In at least some embodiments, the indentation perimeter shape and lateral cross-sectional shape of the docking button indentation 114 and the lateral cross-sectional shape of the docking button 154 facilitate retention or alignment of the mobile device 150 on the cradle 100.

In at least some embodiments, the docking button 154 is removably attached to the case 152 or the mobile device 150. In at least some embodiments, the docking button 154 is permanently attached, or permanently part of, the case 152. In at least some embodiments, the case 152 includes a mounting neck 158, extending away from a back surface 155 of the case upon which the docking button 154 is mounted. In at least some embodiments, the case 152 also includes a platform 156 extending away from the back surface 155 of the case and positioned so that the mounting neck 158 is between the platform 156 and the docking button 154. In other embodiments, a docking button arrangement includes the docking button 154, as well as the mounting neck 158, which is mounted on or mountable on the back surface 155 of the case 152 or the mobile device 150, and, optionally, a platform 156.

In at least some embodiments, the mounting neck 158 has a lateral width that is smaller than a lateral width 160 of the docking button 154. In at least some embodiments, the mounting neck 158 has a lateral width that is smaller than a lateral width of the platform 156. In at least some embodiments, the platform 156 has a lateral width that is larger than a lateral width 160 of the docking button 154. In at least some embodiments, the presence of the mounting neck 158 spaces the radial edge(s) of the docking button 154 away from the back surface 155 of the case 152 (or the back surface of the mobile device) or the platform 156. This arrangement allows a portion of the latch 112 to engage the docking button 154 between the docking button and the back surface 155 of the case 152 (or the back surface of the mobile device) or the platform 156, as illustrated in FIG. 2B.

A cradle 100 can include a latch 112 for engaging the docking button 154. In at least some embodiments, the latch 112 includes a handle 122, a resilient or flexible latch arm 124 coupled to the cradle base 104, and a latching lip 126 configured to engage the docking button 154. Any other suitable latch can be used. In at least some embodiments, the indentation perimeter 116 of the docking button indentation 114 is interrupted by, or partially defined by, the latch 112 (e.g., by the latching lip 126) or elsewhere, as illustrated in FIGS. 2A and 2B. In at least some embodiments, the indentation perimeter 116 of the docking button indentation 114 includes open spaces adjacent to the latch 112. In these embodiments, the shape of the indentation perimeter 116 is considered to be the shape as if these open spaces were filled in. As an example, the shape of the indentation perimeter 116 in FIGS. 1A and 1B is considered to be a regular octagon.

In at least some embodiments, the latch 112 is manually moveable between a latched position and an unlatched position. In at least some embodiments, the latch 112 is biased toward the latched position. In the latched position, the latch 112 directly engages the docking button 154 for retention of the mobile device 150 on the cradle 100. In the unlatched position, the latch 112 disengages from, or is not engaged with, the docking button 154 to permit loading or unloading of the mobile device 150 on the cradle 100. In at least some embodiments, the latch is operable using the handle 112 to move the latch between the latched position and the unlatched position. In at least some embodiments, a docking button 154 pushing against the latching lip 126 of the latch 112 can move the latch from the latched position to the unlatched position for insertion of the docking button 154 into the docking button indentation 114 but pulling the docking button 154 against the latching lip 126 does not result in removing the docking button 154 from the docking button indentation 114. In at least some embodiments, operating the latch handle 122 can result in the resilient latch arm 124 flexing to the unlatched position. In at least some embodiments, the resilient latch arm 124 is biased to maintain the latch 112 in the latched position.

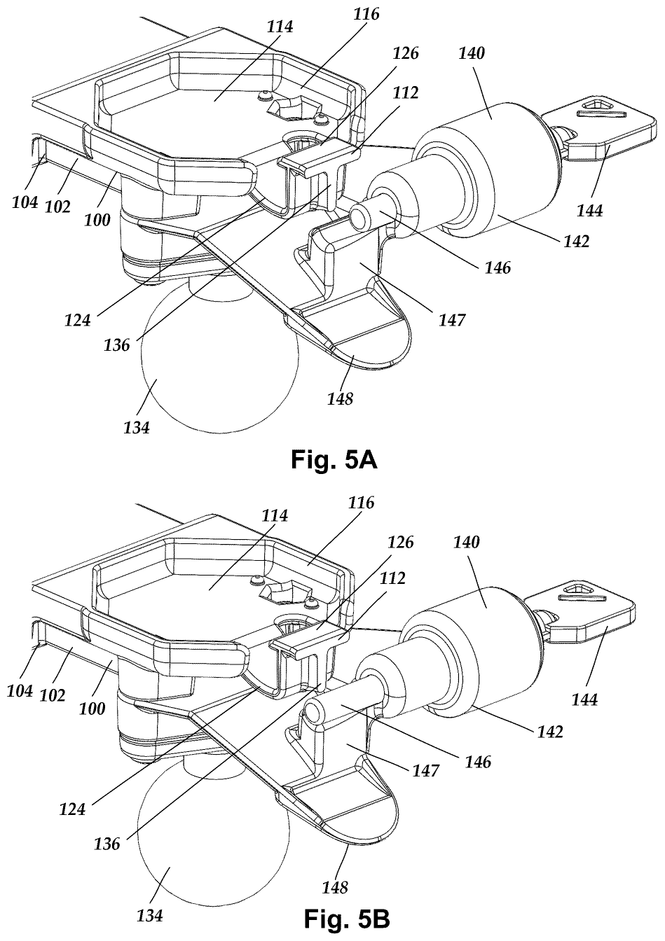

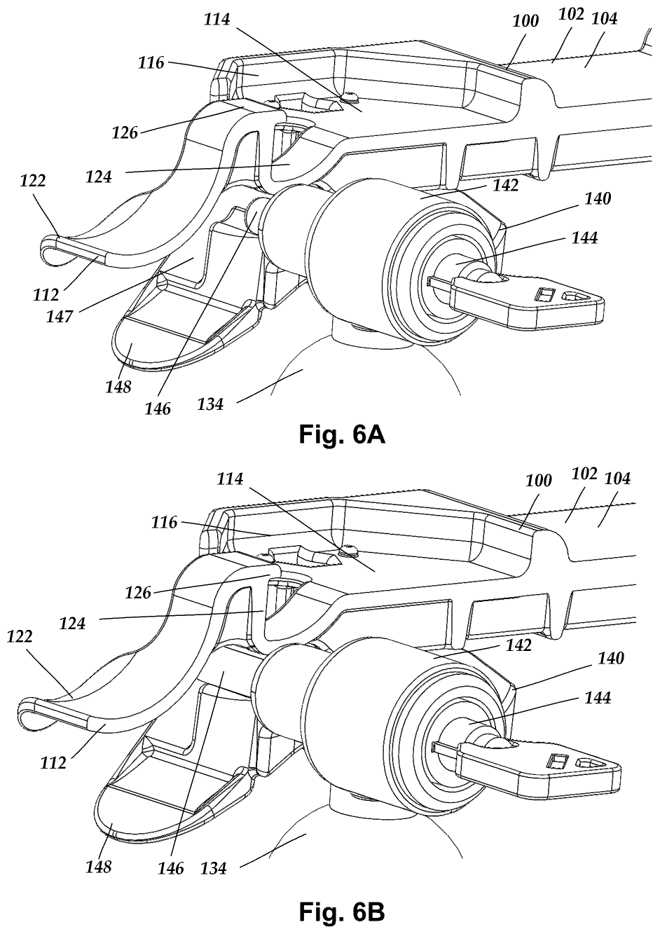

In at least some embodiments, a latch lock 140 is part of, or coupled to, the cradle body 104, as illustrated in FIGS. 5A, 6B, 6A, and 6B. The latch lock 140 is arranged, when in a locked position, to prevent moving the latch 112 to the unlatched position to facilitate retention of the mobile device 150 on the cradle 100. The illustrated embodiment of the latch lock 140 includes a lock body 142, a lock actuator 144, and a latch bar 146. FIGS. 5A and 6A illustrate the latch lock 140 in the unlocked position with the latch bar 146 retracted allowing the latch 112 to move to the unlatched position. FIGS. 5B and 6B illustrate the latch lock 140 in the locked position with the latch bar 146 extended to hinder the latch 112 from moving to the unlatched position.

In the illustrated embodiment, the latch 112 includes a lock engagement feature 136 that engages the latch bar 146 when the latch lock 140 is in the locked position to halt moving the latch to the unlatched position. In at least some embodiments, the lock body 142 (or the cradle base 104) includes a bar platform 147 that a) supports the latch bar 146 when the latch bar 146 is extended or b) provides a stop to movement of the latch 112 while allowing the latch 112 to move to the unlatched position when the latch lock 140 is in the unlocked position or c) both features a) and b). In at least some embodiments, the lock body 142 (or the cradle base 104) includes a latch stop 148 that engages the latch handle 122 as the latch handle moves to the unlatched position to resist bending the latch handle too far and possibly damage the latch 112. In at least some embodiments, the latch stop 148 may also provide a surface that the user can use to pinch the latch handle 122 and latch stop 148 between thumb and finger (or two fingers) to move the latch 112 to the unlatched position.

Any suitable lock actuator 144 can be used. In the illustrated embodiment, the lock actuator 144 is a rotating key actuator which extends or retracts the latch bar 146 as the key 145 is rotated. Other actuators include, but are not limited to, other rotating actuators, a push-button actuator, or the like or any combination thereof.

The cradle 100 can include one or more optional connector cords 108 that is electrically coupled to the contacts 128 and coupleable to a power source, data source, or any combination thereof. An optional connector cord 108 can be hardwired to a device or can include any type of connector 110, as illustrated in FIG. 1A, including, but not limited to, any type of USB connector, a Lightning connector, or the like or any combination thereof. Alternatively, instead of a connector cord, the bottom device receiver 106 can include at least one connector (or jack), such as a female or male connector. A connector cord can be coupled to this connector with the connector cord attached or attachable to a power source, a data source, or any combination thereof. The connector can be any type of connector including, but not limited to, any type of USB connector, a Lightning connector, or the like or any combination thereof.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A cradle for a mobile device, the cradle comprising:
a cradle base defining a docking button indentation having an indentation perimeter, wherein the docking button indentation is configured to receive a docking button disposed on, or coupled to, a back surface of the mobile device or of a case containing the mobile device, the docking button having a lateral cross-sectional shape complementary to the indentation perimeter of the docking button indentation;
a bottom device receiver coupled to the cradle base and configured to receive a bottom portion of the mobile device or the case containing the mobile device, the bottom device receiver comprising a plurality of electrical contacts configured for making contact with contacts on the mobile device or the case containing the mobile device; and
a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

2. The cradle of claim 1, wherein the bottom device receiver is configured to retain a bottom portion of the mobile device or the case.

3. The cradle of claim 1, wherein a portion of the latch defines a portion of the indentation perimeter of the docking button indentation.

4. The cradle of claim 1, wherein the docking button indentation has a polygonal lateral cross-sectional shape.

5. The cradle of claim 1, wherein the indentation perimeter of the docking button indentation has a polygonal shape.

6. The cradle of claim 5, wherein the polygonal shape is selected from triangular, square, rectangular, rhomboidal, trapezoidal, pentagonal, hexagonal, octagonal, or decagonal.

7. The cradle of claim 1, further comprising a latch lock manually moveable between a locked position and an unlocked position, wherein, in the locked position, the latch lock hinders the latch moving to the unlatched position and, in the unlocked position, the latch lock allows the latch to move between the latched position and the unlatched position.

8. The cradle of claim 7, wherein the latch lock comprises a latch bar and a lock actuator coupled to the latch bar and configured to extend the latch bar when the latch lock is moved to the locked position and to retract the latch bar when the latch lock is moved to the unlocked position.

9. The cradle of claim 8, wherein the latch lock further comprises a latch stop configured to engage a portion of the latch when the latch moves to the unlatched position to resist overbending the portion of the latch.

10. The cradle of claim 1, wherein the latch comprises a latch arm coupled to the cradle body, a handle coupled to the latch arm, and a latching lip coupled to the latch arm, wherein the latching lip is configured, in the latched position, to engage the docking button.

11. A kit for docking a mobile device, the kit comprising:
a docking button configured for attachment to a back surface of the mobile device or of a case containing the mobile device, the docking button having a lateral cross-sectional shape; and
a cradle configured for docking the mobile device, the cradle comprising
a cradle base defining a docking button indentation having an indentation perimeter complementary to the lateral cross-sectional shape of the docking button,
a bottom device receiver coupled to the cradle base and configured to receive a bottom portion of the mobile device or the case containing the mobile device, the bottom device receiver comprising a plurality of electrical contacts configured for making contact with contacts on the mobile device or the case containing the mobile device, and
a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

12. The kit of claim 11, further comprising a mounting neck configured for disposition between the docking button and the mobile device or case.

13. The kit of claim 11, further comprising a latch lock manually moveable between a locked position and an unlocked position, wherein, in the locked position, the latch lock hinders the latch moving to the unlatched position and, in the unlocked position, the latch lock allows the latch to move between the latched position and the unlatched position.

14. The kit of claim 13, wherein the latch lock comprises a latch bar and a lock actuator coupled to the latch bar and configured to extend the latch bar when the latch lock is moved to the locked position and to retract the latch bar when the latch lock is moved to the unlocked position.

15. The kit of claim 13, wherein the latch lock further comprises a latch stop configured to engage a portion of the latch when the latch moves to the unlatched position to resist overbending the portion of the latch.

16. A kit for docking a mobile device, the kit comprising:
a case arrangement comprising
a case configured for containing the mobile device, the case comprising a back surface, and
a docking button attached to the back surface of the case, the docking button having a lateral cross-sectional shape; and
a cradle configured for docking the mobile device, the cradle comprising a cradle base defining a docking button indentation having an indentation perimeter complementary to the lateral cross-sectional shape of the docking button,
a bottom device receiver coupled to the cradle base and configured to receive a bottom portion of the case containing the mobile device, the bottom device receiver comprising a plurality of electrical contacts configured for making contact with contacts on the mobile device or the case containing the mobile device, and
a latch coupled to the cradle base and manually moveable between a latched position and an unlatched position, wherein, in the latched position, the latch is configured to directly engage the docking button for retention of the mobile device on the cradle and, in the unlatched position, the latch is configured to disengage from, or not engage with, the docking button to permit loading or unloading of the mobile device on the cradle.

17. The kit of claim 16, further comprising a mounting neck disposed between the docking button and the case.

18. The kit of claim 16, further comprising a latch lock manually moveable between a locked position and an unlocked position, wherein, in the locked position, the latch lock hinders the latch moving to the unlatched position and, in the unlocked position, the latch lock allows the latch to move between the latched position and the unlatched position.

19. The kit of claim 18, wherein the latch lock comprises a latch bar and a lock actuator coupled to the latch bar and configured to extend the latch bar when the latch lock is moved to the locked position and to retract the latch bar when the latch lock is moved to the unlocked position.

20. The kit of claim 19, wherein the latch lock further comprises a latch stop configured to engage a portion of the latch when the latch moves to the unlatched position to resist overbending the portion of the latch.
